(19) United States
(12) Patent Application Publication
(10) Pub. No.: US 2014/0096066 A1
(43) Pub. Date: Apr. 3, 2014

(54) CONSTRUCTION OF COMMAND LINES IN A COMMAND LINE INTERFACE

(71) Applicant: INTERNATIONAL BUSINESS MACHINES CORPORATION, Armonk, NY (US)

(72) Inventors: John J. Auvenshine, Tucson, AZ (US); Erik Bartholomy, Longmont, CO (US); Andrew G. Hourselt, Tucson, AZ (US); John T. Olson, Tucson, AZ (US)

(73) Assignee: INTERNATIONAL BUSINESS MACHINES CORPORATION, Armonk, NY (US)

(21) Appl. No.: 13/631,042

(22) Filed: Sep. 28, 2012

(51) Int. Cl. G06F 3/048

(52) U.S. Cl. 715/780

(57) ABSTRACT

Embodiments of the present invention provide a computer system, method, and computer program product for constructing a command line. According to one aspect of the present invention, a user can construct a command line based on historical command lines. The user can view and select individual historical and/or available parameters to construct the new command line, without requiring that the user manually type the parameters with a physical or virtual keyboard.

### TECHNICAL FIELD

The present invention relates generally to computer systems and, more particularly, to constructing command lines in a command line interface.

### BACKGROUND

Command line shells provide a command line interface to the services of an operating system kernel and other applications. Typically, a user constructs a command line by typing a command name followed by a plurality of parameters. Typing such commands can be a tedious process, particularly where a command line is lengthy or where the computing environment involves limited keyboard access or a virtual keyboard (e.g., a tablet computer or smart phone).

Some command line shells include a history that maintains a record of command lines that have been entered by a user. Later, the user can recall entire command lines from the history and re-execute the command lines or manually type edits.

### SUMMARY

Embodiments of the present invention provide a computer system, method, and computer program product for constructing a command line. According to one aspect of the present invention, a method is provided comprising the steps of: identifying a first command line that has been previously entered by a user in a command line interface, wherein the first command line comprises a first parameter; identifying a second parameter to replace the first parameter; and responsive to the user selecting the second parameter, displaying to the user a second command line in which the first parameter is replaced by the second parameter.

### BRIEF DESCRIPTION OF THE SEVERAL VIEWS OF THE DRAWINGS

FIG. 1 is a functional block diagram of a data processing environment in accordance with an embodiment of the present invention.

FIG. 2 is a flowchart illustrating operational steps for parsing a historical command line in accordance with an embodiment of the present invention.

FIG. 3 is a flowchart illustrating operational steps for constructing a command line in accordance with an embodiment of the present invention.

FIG. 4 is a flowchart illustrating operational steps for constructing a command line in accordance with another embodiment of the present invention.

FIG. 5 shows a hypothetical shell session and historical command lines in accordance with an embodiment of the present invention.

FIG. 6 is a table illustrating a hypothetical relational data structure for the historical command lines of FIG. 5.

FIG. 7 shows a hypothetical shell session in which a user is constructing a command line based on the historical command lines of FIG. 5 in accordance with an embodiment of the present invention.

FIG. 8 shows a hypothetical shell session in which a user is constructing a command line based on the historical command lines of FIG. 5 in accordance with another embodiment of the present invention.

FIG. 9 is a block diagram of internal and external components of the computer system of FIG. 1 in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable mediums having computer-readable program code embodied thereon.

Any combination of one or more computer-readable media may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device. A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Briefly, embodiments of the present invention enable a user to construct command lines based on historical (i.e., previously entered) command lines. A user can view and select individual historical and/or other available parameters to construct a new command line, without requiring that the user manually type the parameters with a physical or virtual keyboard. Accordingly, embodiments of the present invention can enable a user to construct command lines with greater ease and speed than might otherwise be possible by typing command lines on a physical or virtual keyboard.

Embodiments of the present invention will now be described in detail with reference to the accompanying Figures.

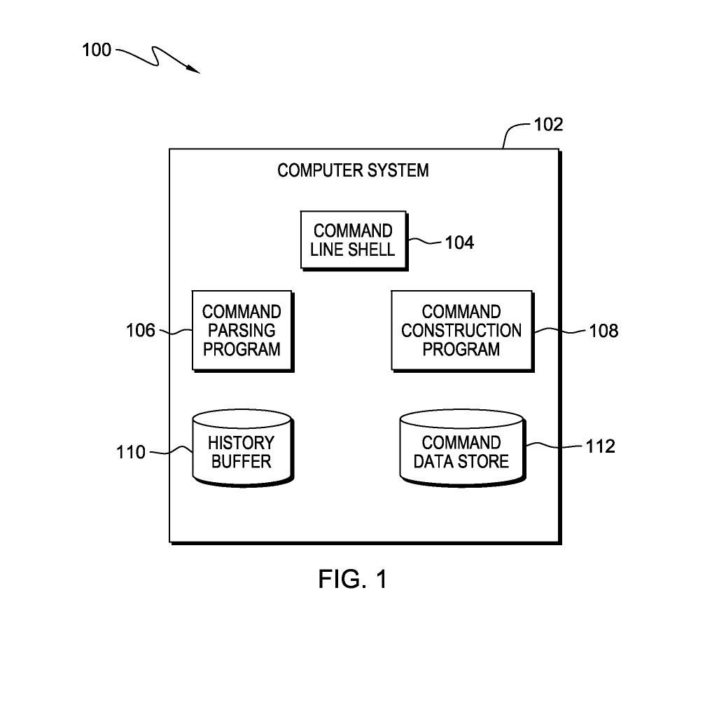

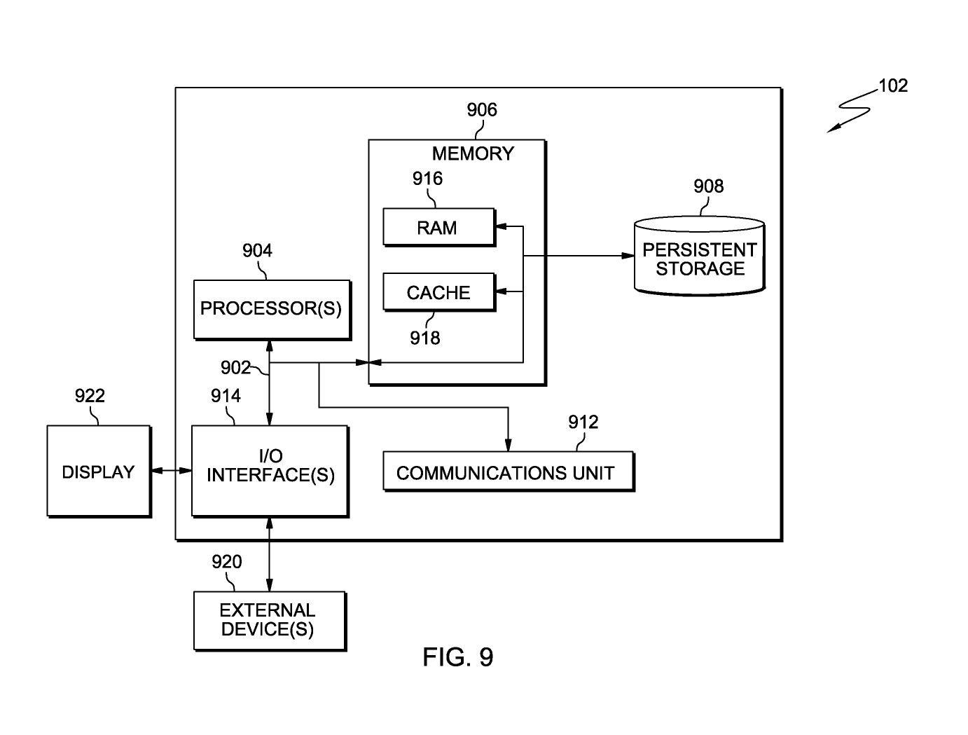

FIG. 1 is a functional block diagram of a data processing environment 100 in accordance with an embodiment of the present invention. Data processing environment 100 includes computer system 102. Computer system 102 can be a desktop computer, laptop computer, cellular telephone (e.g., smart phone), tablet computer, specialized computer server, or any other computer system known in the art. In general, computer system 102 is representative of any electronic device or combination of electronic devices capable of executing machine-readable program instructions, as described in greater detail with regard to FIG. 9.

Computer system 102 includes command line shell 104, command parsing program 106, command construction program 108, history buffer 110, and command data store 112. Command line shell 104 provides a command line interface for one or more operating systems and/or other programs on computer system 102, in which command lines can be entered as one or more command names and parameters. For example, command line shell 104 can be implemented with a UNIX® shell such as Bash, a non-UNIX® shell such as Command Prompt (i.e., as part of the Windows® operating system), or any other command line interpreter. In this exemplary embodiment, command line shell 104 is a UNIX® shell.

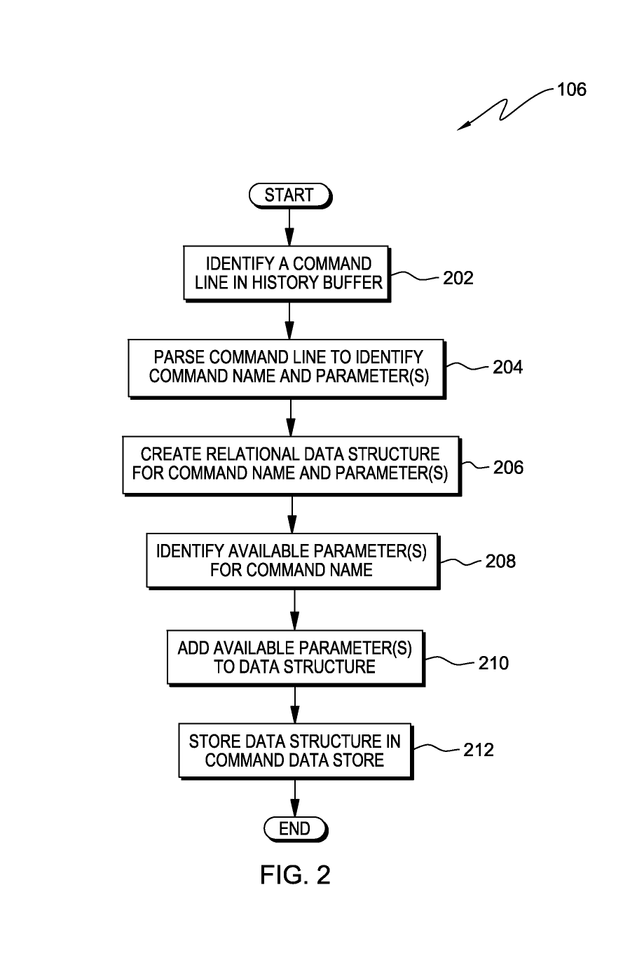

Command parsing program 106 is utilized to parse command lines that have been previously executed and stored in history buffer 110 in accordance with embodiments of the present invention. In this exemplary embodiment, command parsing program 106 parses command lines into command names and parameters in accordance with POSIX-compliant syntax, and stores the command names and parameters in a relational data structure in command data store 112. The term “parameter,” as used in this specification, refers generally to elements of a command line that follow a command name. For example, parameters may include options (i.e., flags or switches), paths, strings, and integers. Command parsing program 106 is discussed in greater detail with regard to FIG. 2.

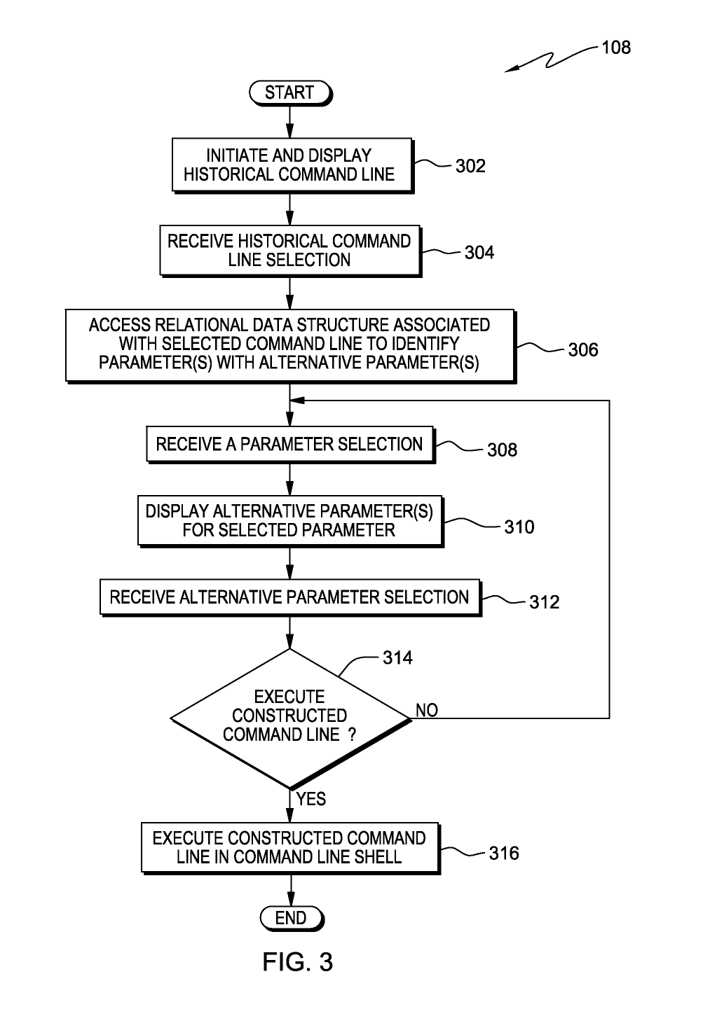

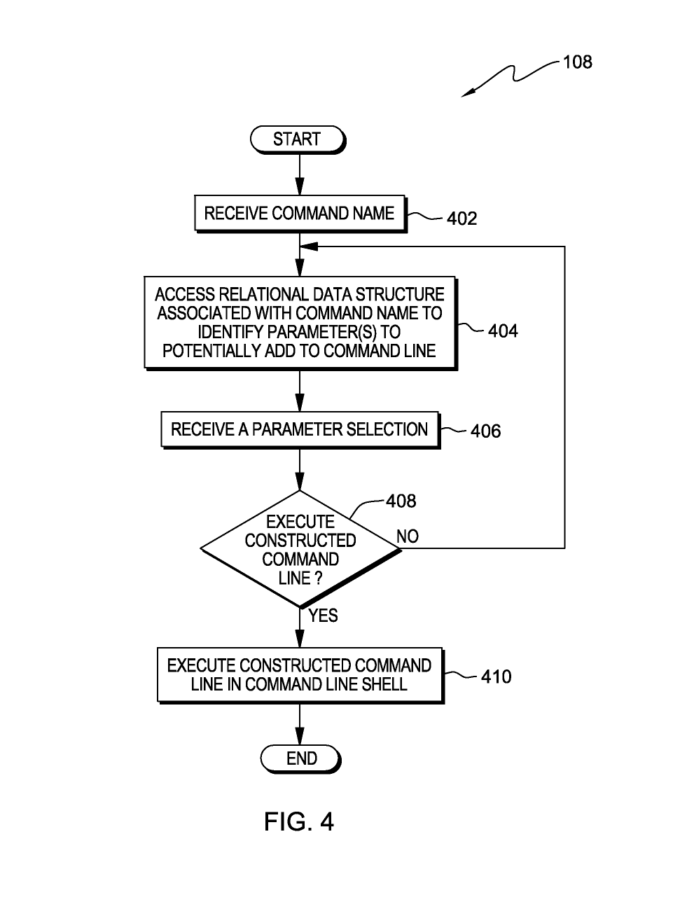

Command construction program 108 is utilized to construct command lines based on historical and/or available commands and parameters in accordance with embodiments of the present invention. In this exemplary embodiment, command construction program 108 enables a user to view and select historical and/or other available parameters to construct new command lines without having to manually type on a physical or virtual keyboard. Command construction program 108 is discussed in greater detail with regard to FIGS. 3 and 4.

History buffer 110 is utilized to store records of command lines that have been entered in command line shell 104 during a user session. In this exemplary embodiment, history buffer 110 is stored locally on computer system 102, such as in random access memory (RAM). In other embodiments, history buffer 110 can be stored remotely on another computer system or storage device.

Command data store 112 is utilized to store records of parsed command lines. In this exemplary embodiment, command data store 112 stores command names and parameters associated with each command line in history buffer 110 using one or more relational data structures that reflect syntactic relationships between parameters. For example, syntactic relationships may include parameters and corresponding sub-parameters (e.g., an option and a corresponding string or integer that modifies the option), and parameters and alternative parameters (e.g., an option that can be replaced with one or more other options in the command line). Such relational data structures can be implemented in any suitable form, such as, for example, tree structures, tables, or relational databases. An example relational data structure is discussed in greater detail with regard to FIG. 6.

FIG. 2 is a flowchart illustrating operational steps of command parsing program 106 for parsing a historical command line in accordance with an embodiment of the present invention. In this exemplary embodiment, command parsing program 106 is initiated each time a command line is entered into command line shell 104 and stored in history buffer 110.

In step 202, command parsing program 106 identifies a command line in history buffer 110 (e.g., the command line most recently entered by a user during the shell session). In step 204, command parsing program 106 parses the command line to identify a command name and one or more parameters (“historical parameters”). In this exemplary embodiment, command parsing program 106 parses the command line in accordance with POSIX-compliant syntax.

In step 206, command parsing program 106 creates a relational data structure that is associated with the command name and reflects syntactic relationships between the historical parameters identified in step 204. For example, the relational data structure may include an identified option and an identified integer that modifies the option.

In step 208, command parsing program 106 identifies one or more available parameters for the identified command name. An available parameter is a parameter that can be utilized with the identified command name in addition to, and/or as an alternative to, a parameter in the command line. In this exemplary embodiment, manual pages (i.e., man pages) are accessed whenever they are installed or updated, and available parameters for command names are scanned and stored locally on computer system 102. Command parsing program 106 searches the stored parameters to identify one or more available parameters that are associated with the identified command name. In other embodiments, command parsing program 106 utilizes a help command (e.g., -help). In general, command parsing program 106 can utilize any self-describing function or command that identifies one or more available parameters for the identified command name.

In step 210, command parsing program 106 adds the identified one or more available parameters to the relational data structure created in step 206. In this exemplary embodiment, the identified one or more available parameters are added to the relation data structure along with a marker in order to distinguish the available parameters from historical parameters. The marker can later be removed in the event an available parameter is utilized in a command line (i.e., when an available parameter becomes a historical parameter). Where appropriate, the syntactic relationship of the identified one or more available parameters as alternative parameters to historical parameters in the command line is also recorded.

In step 212, command parsing program 106 stores the relational data structure in command data store 112.

FIG. 3 is a flowchart illustrating operational steps of command construction program 108 for constructing a command line in accordance with an embodiment of the present invention. In step 302, command construction program 108 is initiated and displays a historical command line in command line shell 104. In this exemplary embodiment, command construction program 108 is initiated when the user presses a hotkey or hotkey combination (e.g., ctrl+up arrow) in command line shell 104, and command construction program 108 recalls the most recently entered historical command line from history buffer 110. Additional hotkey presses enable the user to scroll through any additional historical command lines in history buffer 110 in chronological order. In other embodiments, command construction program 108 is initiated by entering a specific command in command line shell 104 (e.g., entering “history” in Bash, or entering “doskey/history” in Command Prompt), after which a list of all historical command lines in history buffer 110 are displayed to the user. In other embodiments, command construction program 108 is initiated when the user makes a touch screen gesture, such as swiping a finger in an upward direction.

In step 304, command construction program 108 receives a selection of a historical command line that was displayed in step 302. In this exemplary embodiment, the user can select a historical command line by scrolling through the historical command lines, as discussed earlier, and then pressing an enter key or selecting a button. In other embodiments, the user can select a historical command line from a numbered list by entering its corresponding number.

In step 306, command construction program 108 accesses the relational data structure stored in command data store 112 that is associated with the selected command line (i.e., associated with the command name) to identify one or more parameters in the selected command line that have one or more alternative parameters. An alternative parameter is a parameter that can be selected by the user (later, in step 312) to replace an existing parameter in the selected command line. In this exemplary embodiment, alternative parameters may be additional historical parameters (i.e., parameters that were previously entered in command lines that included the same command name) and/or available parameters (i.e., parameters that were identified by command parsing program 106 from a man page associated with the command name). Command construction program 108 highlights for the user the identified one or more parameters that have one or more alternative parameters.

In step 308, command construction program 108 receives a selection at command line shell 104 of one of the one or more parameters identified in step 306 (i.e., a parameter that has one or more alternative parameters). In this exemplary embodiment, the user can scroll left and right to a particular highlighted parameter in the selected command line using hotkeys (e.g., ctrl+left arrow; ctrl+right arrow) and select the parameter by pressing the enter key or selecting a button. In other embodiments, the user can scroll left and right using touch screen gestures (e.g., swiping a finger left and right).

In step 310, command construction program 108 displays the identified one or more alternative parameters for the selected parameter, as stored in the relational data structure, in command line shell 104. The one or more alternative parameters can be displayed to the user one at a time (e.g., as the user scrolls up and down the history of the individual selected parameter using hotkeys) or as list through which the user can scroll. Further, the order in which the one or more alternative parameters are displayed to the user can be based on whether the alternative parameter is a historical parameter or an available parameter (i.e., whether it is marked in the relational data structure). For example, the user may first scroll through historical parameters in chronological order, after which available parameters are displayed. In other embodiments, command construction program 108 displays only displays historical parameters. In other embodiments, the order in which the alternative parameters are displayed is based on the frequency of their use, where parameters that are used with higher frequency (i.e., parameters that were entered in the greatest number of historical command lines) are displayed first. For example, the number of occurrences of each parameter in historical command lines can be recorded in the appropriate relational data structure stored in command data store 112.

In step 312, command construction program 108 receives a selection of an alternative parameter displayed to the user in step 310. Selecting the alternative parameter adds the parameter to the constructed command line. In this exemplary embodiment, the user selects an alternative parameter by pressing the enter key or selecting a button.

In step 314, command construction program 108 determines whether a command has been received to execute the constructed command line. In this exemplary embodiment, command construction program 108 determines whether the user has pressed the enter key again. In other embodiments, the user may press hotkeys or select a button to issue a command to execute the constructed command line.

If, in step 314, command construction program 108 determines that the command has been received to execute the constructed command line, then, in step 316, the constructed command line is executed in command line shell 104. If, in step 314, command construction program 108 determines that the command has not been received to execute the constructed command line, then the operational steps repeat back at step 308, where the user can select other parameters and alternative parameters and continue constructing the command line.

FIG. 4 is a flowchart illustrating operational steps of command construction program 108 for constructing a command line in accordance with another embodiment of the present invention. In this exemplary embodiment, the user can construct a command line in a parameter-by-parameter fashion (e.g., type-ahead or auto-complete fashion), as opposed to recalling a historical command line and selecting alternative parameters, as discussed with regard to FIG. 3.

In step 402, command construction program 108 receives a command name. In this exemplary embodiment, the user types the command name in command line shell 104. In other embodiments, command construction program 108 displays a list of historical command names stored in command data store 112 from which the user can select.

In step 404, command construction program 108 accesses the relational data structure stored in command data store 112 that is associated with the command name received in step 402 to identify one or more parameters to potentially add to the command line. That is, command construction program 108 identifies one or more parameters to potentially add to the command line after the command name. The parameters can include historical parameters and available parameters, as previously discussed with regard to FIG. 3. In this exemplary embodiment, command construction program 108 displays the identified one or more parameters to the user in a list from which the user can select.

In step 406, command construction program 108 receives a selection of a parameter identified and displayed in step 404. Selecting the parameter adds the parameter to the constructed command line. In this exemplary embodiment, the user selects a parameter by pressing the enter key or selecting a button.

In step 408, command construction program 108 determines whether a command has been received to execute the constructed command line. In this exemplary embodiment, command construction program 108 determines whether the user has pressed the enter key again. In other embodiments, the user may press hotkeys or select a button to issue a command to execute the constructed command line.

If, in step 408, command construction program 108 determines that the command has been received to execute the constructed command line, then, in step 410, the constructed command line is executed in command line shell 104. If, in step 408, command construction program 108 determines that the command has not been received to execute the constructed command line, then the operational steps repeat back at step 404, where command construction program 108 accesses the relational data structure stored in command data store 112 that is associated with the command name received in step 402 to identify one or more additional parameters to potentially add to the command line.

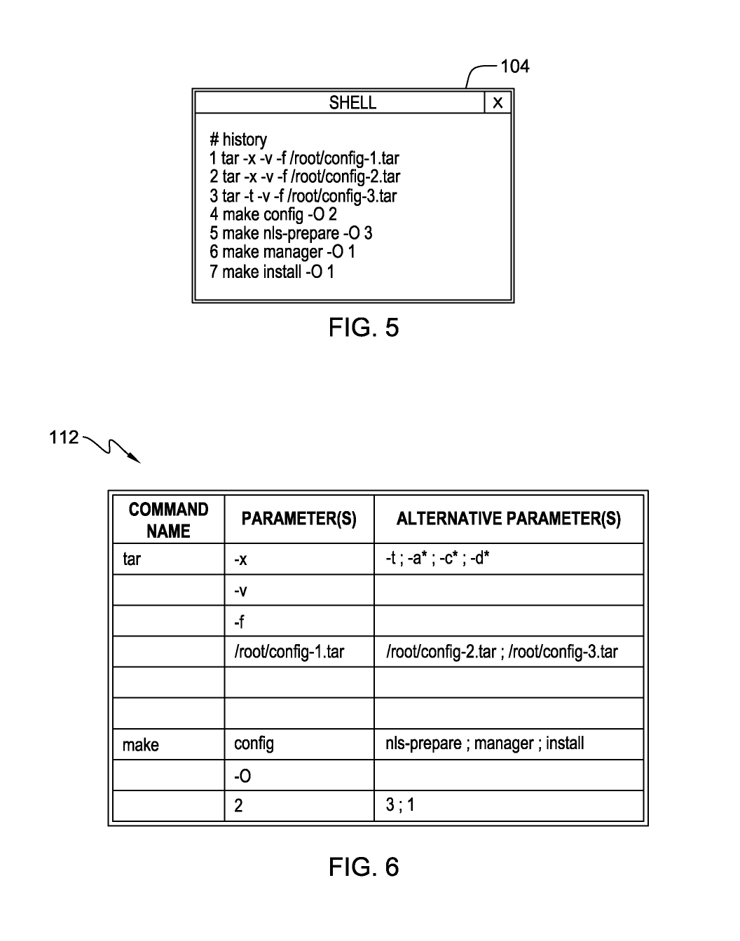

FIG. 5 shows a hypothetical session in command line shell 104 in accordance with an embodiment of the present invention. In this hypothetical, the user is utilizing command line shell 104 within a graphical window. The user has entered a “history” command, after which seven historical command lines have been displayed. Each of the seven historical command lines includes multiple parameters, as discussed in greater detail with regard to FIG. 6.

FIG. 6 is a table illustrating a hypothetical relational data structure stored in command data store 112 after parsing the historical command lines of FIG. 5. It should be appreciated that this example is presented for illustrative purposes and is not necessarily intended to depict an actual relational data structure.

In this example, the first (i.e., oldest) historical command line of FIG. 5 was parsed first. Accordingly, the “COMMAND NAME” column contains the command name of the first command line (i.e., “tar”), and the “PARAMETER(S)” column contains each of the parameters (i.e., “-x”, “-v”, and “-f”, and the path “/root/config-1.tar”). The second and third command lines of FIG. 5 were subsequently entered into command line shell 104, parsed, and added to the relational data structure associated with the “tar” command name. Each entry in the “ALTERNATIVE PARAMETER(S)” column includes identified alternative parameters for the adjacent historical parameters. For the “tar” command name, the alternative parameters include additional historical parameters (i.e., “-t”, “/root/config-2.tar”, and “/root/config-3.tar”) as well as available parameters, as marked with an asterisk (i.e., “-a*”, “-c*”, and “-d*”). It should also be appreciated that, for each parameter in the “ALTERNATIVE PARAMETER(S)” column, alternatives include the adjacent parameters in the “PARAMETER(S)” column as well as the remaining parameters in the “ALTERNATIVE PARAMETER(S)” column. For example, alternative parameters for “-c*” include “-x”, “-t”, “-a*”, and “-d*”.

In this example, the fourth command line of FIG. 5 was the first historical command line to be parsed that was not associated with the command name “tar”. Accordingly, the “COMMAND NAME” column next contains the command name “make”, and the “PARAMETER(S)” column contains each of the parameters of the fourth command line (i.e., “config”, “-O”, and “2”). The fifth through seventh command lines of FIG. 5 were subsequently entered into command line shell 104, parsed, and added to the relational data structure associated with the “make” command name. For the “make” command name, the alternative parameters include additional historical parameters (i.e., “nls-prepare”, “manager”, “install”, “3”, and “1”).

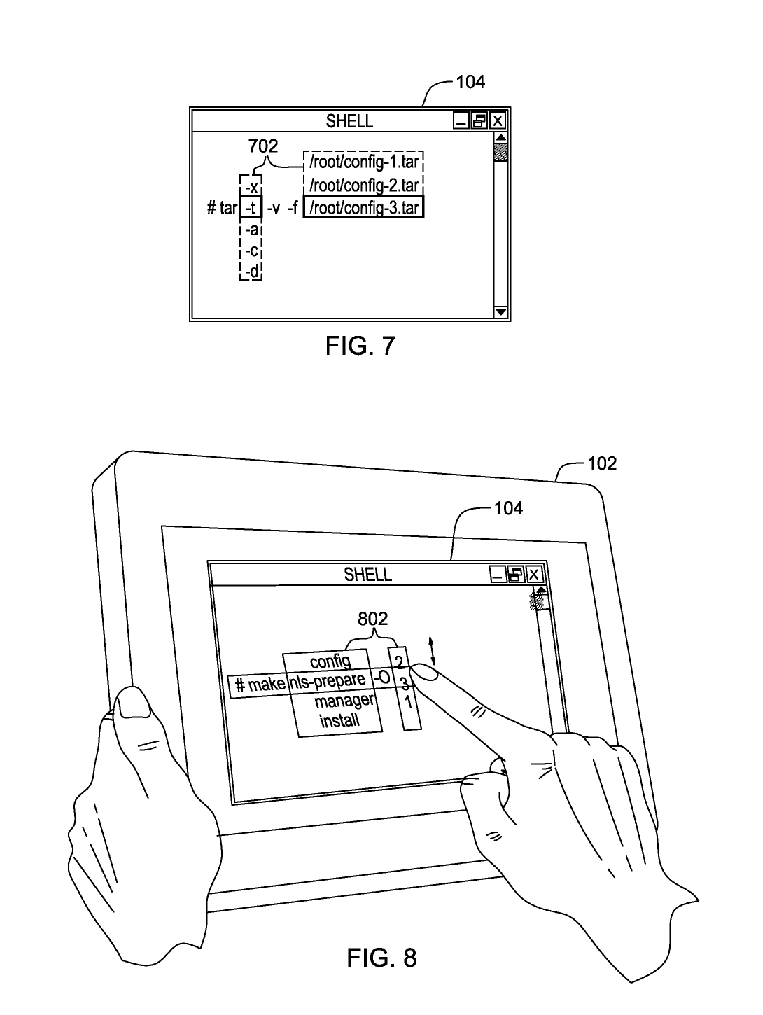

FIG. 7 shows a hypothetical session in command line shell 104 in which a user is constructing a command line based on the historical command lines of FIG. 5 and the relational data structure of FIG. 6 in accordance with an embodiment of the present invention. In this example, the user is utilizing command line shell 104 within a graphical window, and the user is interacting with command line shell 104 using a keyboard. The third historical command line of FIG. 5 was selected by the user, and the parameters of the command line for which there are alternative parameters (i.e., “-t” and “/root/config-3.tar”) have been highlighted for the user, as shown with bolded lines. In this example, the alternative parameters 702 are not all displayed to the user, as shown with dotted lines; instead, the user can navigate to a parameter and scroll through and view each alternative parameter, one at a time, using the keyboard. The user can then select one or more alternative parameters to construct a new command line.

FIG. 8 shows a hypothetical session in command line shell 104 in which a user is constructing a command line based on the historical command lines of FIG. 5 and the relational data structure of FIG. 6 in accordance with another embodiment of the present invention. In this example, computer system 102 is a tablet computer, and the user is utilizing command line shell 104 within a graphical window by touching a touch screen. As shown, the fifth historical command line of FIG. 5 was selected by the user, and the parameters of the command line for which there are alternative parameters (i.e., “nls-prepare” and “3”) have been highlighted for the user. In this example, the alternative parameters 802 are all displayed to the user, as shown with solid lines. To construct a new command line, the user can navigate to different parameters in the command line using leftward and rightward finger swipes, and the user can scroll through alternative parameters 802 using upward and downward finger swipes. As depicted, the user is scrolling from “3” to “2” to construct the new command line: “make nls-prepare -O 2”.

FIG. 9 is a block diagram of internal and external components of computer system 102 in accordance with an embodiment of the present invention. It should be appreciated that FIG. 9 provides only an illustration of one implementation and does not imply any limitations with regard to the environments in which different embodiments may be implemented. In general, the components illustrated in FIG. 9 are representative of any electronic device capable of executing machine-readable program instructions. Examples of computer systems, environments, and/or configurations that may be represented by the components illustrated in FIG. 9 include, but are not limited to, personal computer systems, server computer systems, thin clients, thick clients, laptop computer systems, tablet computer systems, cellular telephones (e.g., smart phones), multiprocessor systems, microprocessor-based systems, network PCs, minicomputer systems, mainframe computer systems, and distributed cloud computing environments that include any of the above systems or devices.

Computer system 102 includes communications fabric 902, which provides for communications between one or more processors 904, memory 906, persistent storage 908, communications unit 912, and one or more input/output (I/O) interfaces 914. Communications fabric 902 can be implemented with any architecture designed for passing data and/or control information between processors (such as microprocessors, communications and network processors, etc.), system memory, peripheral devices, and any other hardware components within a system. For example, communications fabric 902 can be implemented with one or more buses.

Memory 906 and persistent storage 908 are computer-readable storage media. In this embodiment, memory 906 includes random access memory (RAM) 916 and cache memory 918. In general, memory 906 can include any suitable volatile or non-volatile computer-readable storage media. In this embodiment, one or more operating systems, command line shell 104, command parsing program 106, command construction program 108, and command data store 112 are stored in persistent storage 908 for execution and/or access by one or more of the respective processors 904 via one or more memories of memory 906. History buffer 110 can be stored in memory 906 and/or persistent storage 908.

In this embodiment, persistent storage 908 includes a magnetic hard disk drive. Alternatively, or in addition to a magnetic hard disk drive, persistent storage 908 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 908 can also be removable. For example, a removable hard drive can be used for persistent storage 908. Other examples include optical and magnetic disks, thumb drives, and smart cards that are inserted into a drive for transfer onto another computer-readable storage medium that is also part of persistent storage 908.

Communications unit 912 provides for communications with other computer systems or devices via a network. In this exemplary embodiment, communications unit 912 includes network adapters or interfaces such as a TCP/IP adapter cards, wireless Wi-Fi interface cards, or 3G or 4G wireless interface cards or other wired or wireless communication links. The network can comprise, for example, copper wires, optical fibers, wireless transmission, routers, firewalls, switches, gateway computers and/or edge servers. Software and data used to practice embodiments of the present invention can be downloaded to computer system 102 through communications unit 912 (e.g., via the Internet, a local area network or other wide area network). From communications unit 912, the software and data can be loaded onto persistent storage 908.

One or more I/O interfaces 914 allow for input and output of data with other devices that may be connected to computer system 102. For example, I/O interface 914 can provide a connection to one or more external devices 920 such as a keyboard, computer mouse, touch screen, virtual keyboard, touch pad, pointing device, or other human interface devices. External devices 920 can also include portable computer-readable storage media such as, for example, thumb drives, portable optical or magnetic disks, and memory cards. I/O interface 914 also connects to display 922.

Display 922 provides a mechanism to display data to a user and can be, for example, a computer monitor. Display 922 can also be an incorporated display and may function as a touch screen, such as a built-in display of a tablet computer.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The foregoing description of various embodiments of the present invention has been presented for purposes of illustration and description. It is not intended to be exhaustive nor limit the invention to the precise form disclosed. Many modifications and variations of the present invention are possible. Such modifications and variations that may be apparent to a person skilled in the art of the invention are intended to be included within the scope of the invention as defined by the accompanying claims.

What is claimed is:

1. A method for constructing a command line, the method comprising the steps of:
identifying a first command line that has been previously entered by a user in a command line interface, wherein the first command line comprises a first parameter;
identifying a second parameter to replace the first parameter; and
responsive to the user selecting the second parameter, displaying to the user a second command line in which the first parameter is replaced by the second parameter.

2. The method of claim 1, wherein the second parameter is a parameter that has been previously entered by the user in the command line interface and stored in a history.

3. The method of claim 1, wherein the second parameter is a parameter that has not been previously entered by the user in the command line interface and stored in a history.

4. The method of claim 1, further comprising the steps of:
parsing the first command line into a command name and one or more parameters, wherein the one or more parameters include the first parameter; and
creating a relational data structure.

5. The method of claim 4, wherein the second parameter is identified utilizing the relational data structure.

6. A computer system for constructing a command line, the computer system comprising:
one or more processors, one or more computer-readable memories, one or more computer-readable storage media, and program instructions stored on at least one of the one or more computer-readable storage media that, when executed by at least one of the one or more processors via at least one of the one or more computer-readable memories, perform the method of claim 1.

7. A method for constructing a command line, the method comprising the steps of:
receiving a command name at a command line interface, wherein the command name has been previously entered by a user in the command line interface;
identifying a parameter that is associated with the command name; and
responsive to the user selecting the parameter, displaying to the user a command line comprising the command name and the parameter.

8. The method of claim 7, wherein the parameter is a parameter that has been previously entered by the user in the command line interface and stored in a history.

9. The method of claim 7, wherein the parameter is a parameter that has not been previously entered by the user in the command line interface and stored in a history.

10. The method of claim 7, further comprising the steps of:
parsing a command line into the command name and one or more parameters, wherein the one or more parameters include the parameter; and
creating a relational data structure.

11. The method of claim 10, wherein the parameter is identified utilizing the relational data structure.

12. A computer system for constructing a command line, the computer system comprising:
one or more processors, one or more computer-readable memories, one or more computer-readable storage media, and program instructions stored on at least one of the one or more computer-readable storage media that, when executed by at least one of the one or more processors via at least one of the one or more computer-readable memories, perform the method of claim 7.

13. A computer program product for constructing a command line, the computer program product comprising:
one or more computer-readable storage media and program instructions stored on at least one of the one or more computer-readable storage media, the program instructions comprising:
program instructions to identify a first command line that has been previously entered by a user in a command line interface, wherein the first command line comprises a first parameter;
program instructions to identify a second parameter to replace the first parameter; and
program instructions to, responsive to the user selecting the second parameter, display to the user a second command line in which the first parameter is replaced by the second parameter.

14. The computer program product of claim 13, wherein the second parameter is a parameter that has been previously entered by the user in the command line interface and stored in a history.

15. The computer program product of claim 13, wherein the second parameter is a parameter that has not been previously entered by the user in the command line interface and stored in a history.

16. The computer program product of claim 13, wherein the program instructions stored on at least one of the one or more computer-readable storage media further comprise program instructions to:
parse the first command line into a command name and one or more parameters, wherein the one or more parameters include the first parameter; and
create a relational data structure.

17. The computer program product of claim 16, wherein the second parameter is identified utilizing the relational data structure.

18. A computer program product for constructing a command line, the computer program product comprising:
one or more computer-readable storage media and program instructions stored on at least one of the one or more computer-readable storage media, the program instructions comprising:
program instructions to receive a command name at a command line interface, wherein the command name has been previously entered by a user in the command line interface;
program instructions to identify a parameter that is associated with the command name; and
program instructions to, responsive to the user selecting the parameter, display to the user a command line comprising the command name and the parameter.

19. The computer program product of claim 18, wherein the parameter is a parameter that has been previously entered by the user in the command line interface and stored in a history.

20. The computer program product of claim 18, wherein the parameter is a parameter that has not been previously entered by the user in the command line interface and stored in a history

21. The computer program product of claim 18, wherein the program instructions stored on at least one of the one or more computer-readable storage media further comprise program instructions to:
parse a command line into the command name and one or more parameters, wherein the one or more parameters include the parameter; and
create a relational data structure.

22. The computer program product of claim 21, wherein the parameter is identified utilizing the relational data structure.
